(19) United States
(12) Patent Application Publication
(10) Pub. No.: US 2006/0215665 A1
(43) Pub. Date: Sep. 28, 2006

(54) Paths in telecommunications networks

(76) Inventors: William Campbell, Widnes (GB); Paul Booker, Tarporley, Cheshire (GB); Russell Smith, Wirral (GB)

Correspondence Address: KIRSCHSTEIN, OTTINGER, ISRAEL;& SCHIFFMILLER, P.C., 489 FIFTH AVENUE, NEW YORK, NY, 10017, US

(21) Appl. No.: 10/550,496

(22) PCT Filed: Mar. 12, 2004
(86) PCT No.: PCT/GB04/01064

§ 371 Date: Sep. 20, 2005

(30) Foreign Application Priority Data
Mar. 21, 2003 (GB) 0306536.4

(51) Int. Cl. H04L 12/56

(52) U.S. Cl. 370/397; 370/399

(57) ABSTRACT

A telecommunications network is provided, comprising a plurality of network elements, switching means, and a traffic stream controller, wherein, for each network element, there is provided a set of outgoing paths from the network element to the switching means, one outgoing path carrying traffic streams for each of the network elements, and an incoming path carrying traffic streams from the switching means to the network element, the switching means merges each outgoing path carrying traffic streams for the network element onto the incoming path of the network element, to route traffic streams from each of the network elements to the network element, and routing of the traffic streams to the network element is controlled by the network element using the traffic stream controller. The telecommunications network thus comprises a merged mesh of paths, which fully interconnects all of the network elements. Each outgoing path and incoming path may comprise a permanent virtual path (PVP). For each network element, control of routing of the traffic streams to the network element may comprise control of usage of the incoming path bandwidth of the network element.

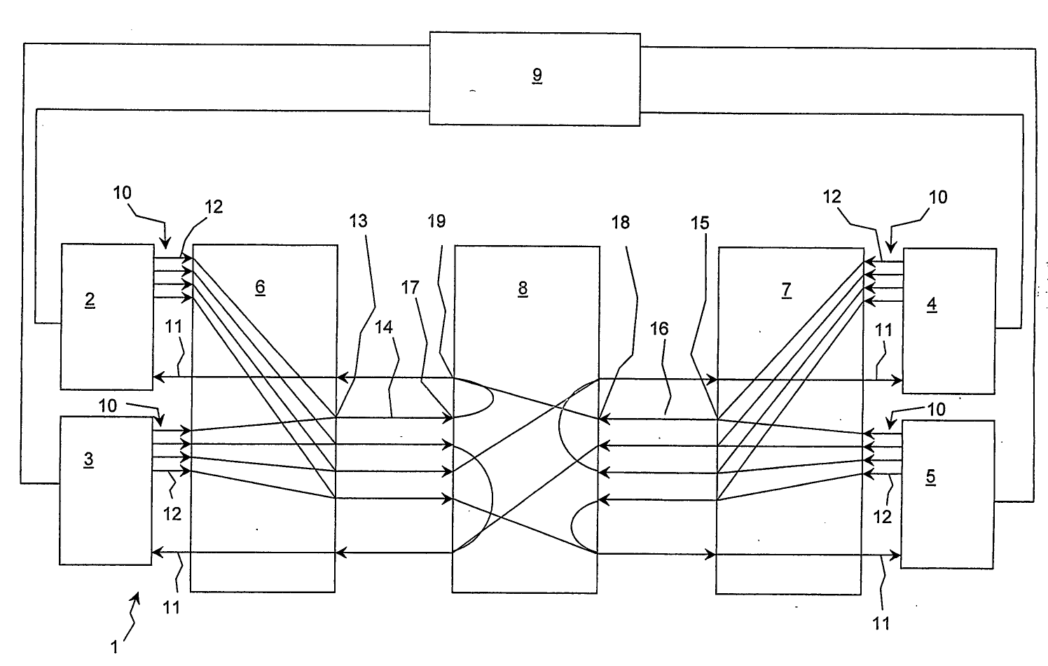

This invention relates to paths in telecommunications networks, and particularly to permanent virtual paths (PVPs) in such a network.

In known telecommunications networks, traffic streams are routed around the network using switches. In some networks, each switch is dynamic, i.e. when a switch receives signalling associated with a traffic stream it interrogates the signalling to determine the intended destination of the traffic stream, and sets up an appropriate path for the traffic stream. This allows efficient use of the network resources such as bandwidth, which is only consumed when required. However, the processing of the signalling and the establishment of the path puts a considerable work load on each switch, and routing of traffic streams through such a network can be slower than desired.

An alternative to the above type of network, is to establish paths, such as PVPS, between all possible traffic stream sources and destinations. The paths for all traffic streams will be permanently set up in each switch of such a network, and when a switch receives a traffic stream it does not have to work to create an appropriate path, as the path has already been established. This decreases the processing necessary in each switch, and increases the speed of routing traffic streams through the network. However, as the number of sources and destinations in such a network grows, the number of required paths also grows, and can become difficult to manage. In addition, in each switch, each physical port is shared by many paths, and the aggregate bandwidth of the individual paths must be less than or equal to the port bandwidth, for e.g. constant bit rate (CBR) traffic streams. When the aggregate bandwidth of the individual paths is equal to the port bandwidth, if it is desired to add more paths to the port, then the bandwidth available for each path must be reduced. This available bandwidth may become unacceptably small.

It is desirable to be able to use the advantage of paths such as PVPs in a telecommunications network, without the associated disadvantages, for example the number of such paths becoming unmanageable.

According to the present invention, there is provided a telecommunications network comprising a plurality of network elements, switching means, and a traffic stream controller, wherein, for each network element, there is provided a set of outgoing paths from the network element to the switching means, one outgoing path carrying traffic streams for each of the network elements, and an incoming path carrying traffic streams from the switching means to the network element, to route traffic streams from each of the network elements to the network element, the switching means merges each outgoing path carrying traffic streams for the network element onto the incoming path of the network element, and routing of the traffic streams to the network element is controlled by the network element using the traffic stream controller.

The telecommunications network thus comprises a merged mesh of paths, which fully interconnects all of the network elements. Paths within the switching means may be permanently set up. This reduces the work load of the switching means, and increases the speed of routing traffic streams through the network. The number of paths in the telecommunications network required to create such a fully interconnected mesh is reduced by merging individual outgoing paths onto a single incoming path. Thus larger networks may be built, which can be more efficient and less difficult to manage.

Each outgoing path may comprise a permanent virtual path (PVP), such as a constant bit rate (CBR) PVP. Each incoming path may comprise a permanent virtual path (PVP), such as a CBR PVP. The or each or some of the network elements may comprise a gateway network element.

For each network element, control of routing of the traffic streams to the network element may comprise control of usage of the incoming path bandwidth of the network element. Each network element may control usage of the incoming path bandwidth by using information received from the traffic stream controller. The information received from the traffic stream controller may comprise information concerning each of the traffic streams which the network element is to receive. The information received from the traffic stream controller may comprise information concerning the bandwidth of each of the traffic streams which the network element is to receive. Each network element may use the information received from the traffic stream controller to calculate the aggregate bandwidth of any traffic streams being carried on the incoming path of the network element and each of the traffic streams which it is to receive. Each network element may check that the aggregate bandwidth does not exceed the incoming path bandwidth of the network element. Each network element may reject one or more of the traffic streams which it is to receive, if the aggregate bandwidth exceeds the incoming path bandwidth. Each network element may control usage of the incoming path bandwidth by using a bandwidth control algorithm, which may be provided on each network element. Each network element may control usage of the incoming path bandwidth to maintain a part of the bandwidth for one or more types of traffic streams, e.g. telephone calls to emergency services.

For each network element, the incoming path may come from an egress port of the switching means. For each network element, the incoming path bandwidth may be less than or equal to the bandwidth of an egress port of the switching means from which the incoming path comes. For each network element, each outgoing path may have a bandwidth less than or equal to the bandwidth of the network element incoming path onto which the outgoing path is merged. Thus each individual outgoing path can deliver up to the maximum bandwidth capacity of the network element incoming path onto which the outgoing path is merged.

For each network element, control of routing of the traffic streams to the network element from each of the network elements may comprise the network elements exchanging network element identities via the traffic stream controller. The network element identities may determine the paths to be used for the traffic streams.

For each network element, control of routing of the traffic streams to the network element may comprise setting up a virtual connection (VC) for each traffic stream, within an outgoing path carrying the traffic stream and the incoming path of the network element. This may be achieved by using a VC allocation algorithm, which may be provided on each network element, for example on a destination function of the network element. Setting up each VC may comprise allocating a VC identifier (VCI) to each VC. Allocating a VCI to each VC may comprise the network element choosing a VCI for each VC. Allocating a VCI to each VC may comprise the network element communicating a chosen VCI to each of the network elements of the telecommunications network. Communicating a chosen VCI may be achieved via the traffic stream controller. For example, for each network element setting up a VC for a traffic stream may comprise the following steps: the traffic stream controller informs the network element that a traffic stream is to be sent to it from a source network element; the network element chooses a VCI for a VC for the traffic stream; the network element communicates the chosen VCI to the traffic stream controller; the traffic stream controller communicates the chosen VCI to the source network element; and the source network element assigns the traffic stream to a VC having the VCI. Each network element may therefore control the VCIs of the VCs for the traffic streams it receives. This ensures that each traffic stream is received by the network element on a unique VC, and avoids receiving two different traffic streams on the same VC, which would otherwise result in mixing of these traffic streams.

The telecommunications network may provide a constant bit rate (CBR) service. The telecommunications network may provide a CBR service with symmetric dynamic connections, or asymmetric dynamic connections. The telecommunications network may provide a 64 kbit telephony CBR service. The telecommunications network may route CBR traffic streams. The quality of service (QOS) for CBR traffic streams may be maintained when all of the incoming path bandwidth of a network element is being used by the CBR traffic streams, by the network element refusing to accept any further CBR traffic streams.

The switching means may comprise one or more switches of the telecommunications network, for example, an edge switch, or a core switch, or a combination of one or more edge switches and one or more core switches. For each network element, the outgoing paths carrying traffic streams for the network element may be merged in one or more stages. For each network element, the outgoing paths carrying traffic streams for the network element may be merged in one or more stages using one or more switches of the switching means. For example, for each network element, a first group of outgoing paths carrying traffic streams for the network element may be merged in a first stage, a second group of outgoing paths comprising the remaining outgoing paths carrying traffic streams for the network element may be merged in a second stage, and the first and second groups of outgoing paths may be merged in a third stage onto the incoming path of the network element. The first group of outgoing paths may be merged using a first switch of the switching means, e.g. an edge switch, the second group of outgoing paths may be merged using a second switch of the switching means, e.g. an edge switch, and the first and second groups may be merged using a third switch of the switching means, e.g. a core switch, connected between the first and second switches.

For each network element, each outgoing path and the incoming path may be set up when the network element is installed in the telecommunications network. For each network element, the merging of outgoing paths carrying traffic streams for the network element onto the incoming path of the network element may be set up when the switching means is installed in the telecommunications network. It is then possible that no further configuration management of the network elements or the switching means will be required.

The telecommunications network may be split into a plurality of zones. Each zone may comprise a plurality of network elements, switching means and a traffic stream controller, as described above. Each zone may be interconnected to other zones using one or more trunking routes. Each zone may use a traffic stream controller to interwork with other zones to set up traffic streams between zones using the trunking routes. This will allow larger telecommunications networks to be created.

The telecommunications network may comprise an asynchronous transfer mode (ATM) telecommunications network.

The switching means may be provided in an edge switch of the telecommunications network. The edge switch may be connected via a single ingress port to an egress port of a core switch of the telecommunications network. Each incoming path to a network element may be connected via the ingress port of the edge switch. The bandwidth of the ingress port of the edge switch may be split between each of the incoming paths connected to that port. The edge switch will connect each incoming path to an egress port that is connected to the relevant network element.

When supporting a CBR service, each of the outgoing paths from a network element needs to be able to carry the full outgoing bandwidth of the network element, as it is possible for all traffic streams from an originating network element to be connected to a single destination network element. As there are several outgoing paths per network element, one for each destination network element, the total required outgoing bandwidth is the summation of all the outgoing path bandwidths from the network element. However, this is a worst case scenario because if all of the outgoing traffic streams are on one outgoing path, all of the other outgoing paths from the originating network element will be empty. Hence, to optimise bandwidth utilisation, the outgoing paths are treated as a group of paths, and the outgoing bandwidth from the network element is booked for the group as an aggregated bandwidth. In this case, the aggregated bandwidth for the group of paths will be equal to the maximum outgoing bandwidth of the network element. Any outgoing path within the group is allowed to use up to this maximum bandwidth, and because the network element monitors the set-up of all calls and allocation of VCs within the group of outgoing paths, it can ensure that the total bandwidth of the group never exceeds the maximum. The principle is also applied to the link between the edge switch egress port and the core switch ingress port, where the outgoing paths are merged. At this point, the aggregated bandwidth of the group of outgoing paths is equal to the summation of the maximum outgoing bandwidth of the network elements that are connected to the outgoing paths.

It is possible to refine the above outgoing bandwidth allocation configuration rule if the network elements are sub-equipped and the call set-up algorithm is configured to use a corresponding reduced outgoing bandwidths. Then the aggregated bandwidth of the group of outgoing paths can be configured as the sum of the individual configured network element bandwidths rather than the maximum network element bandwidth, thus optimising the use of bandwidth further but increasing the complexity of the management task.

Allocating a fixed bandwidth to the group allows other services with different quality of service (QOS) to set up connections on the switches, and utilise any remaining bandwidth without affecting the QOS of the group which behaves as a CBR path.

An embodiment of the invention will now be described, by way of example only, with reference to the drawing which is a schematic representation of a telecommunications network according to the invention.

The telecommunications network 1 of the drawing is an ATM telecommunications network, and comprises four gateway network elements 2, 3, 4 and 5, switching means comprising a first ATM edge switch 6, a second ATM edge switch 7, and an ATM core switch 8, and a traffic stream controller 9. Each gateway network element has four uni-directional outgoing paths 10 (one outgoing path carrying traffic streams for each of the other gateway network elements and one outgoing path carrying traffic streams back to the network element), and a single uni-directional incoming path 11. The outgoing paths 10 of gateway network elements 2, 3 go to the first ATM edge switch 6, and the outgoing paths 10 of gateway network elements 4, 5 go to the second ATM edge switch 7. Similarly, the incoming paths 11 of gateway network elements 2, 3 come from the first ATM edge switch 6, and the incoming paths 11 of gateway network elements 4, 5 come from the second ATM edge switch 7. The first and second ATM edge switches 6, 7 are connected to the ATM core switch 8. Each gateway network element 2, 3, 4 and 5 is connected to the traffic stream controller 9.

The operation of the telecommunications network 1 with regard to routing traffic streams to each gateway network element 2, 3, 4 and 5 is similar, and the routing of traffic streams to only gateway network element 2 will therefore be described in detail.

Each of the gateway network elements 2, 3, 4, 5 has a outgoing path 12 carrying traffic streams for the gateway network element 2. These outgoing paths 12 are merged by the switches of the switching means in the following,manner. The outgoing path 12 of gateway network element 2 and the outgoing path 12 of gateway network element 3 are merged onto an egress port 13 of ATM edge switch 6, which is connected to a merged path 14. Similarly, the outgoing path 12 of gateway network element 4 and the outgoing path 12 of gateway network element 5 are merged onto an egress port 15 of ATM edge switch 7, which is connected to a merged path 16. The merged path 14 is connected to an ingress port 17 of ATM core switch 8, and the merged path 16 is connected to an ingress port 18 of ATM core switch 8. The ATM core switch 8 merges the two merged paths 14, 16 onto an egress port 19 of this switch 8, which is connected to the incoming path 11 of the gateway network element 2. Thus each of the outgoing paths 10 carrying traffic streams for the gateway network element 2 are merged by the switching means onto the incoming path 11 of each gateway network element 2, 3, 4 and 5.

Routing of the traffic streams to a gateway network element 2, 3, 4 and 5 is controlled by the gateway network element using the traffic stream controller 9. This comprises controlling usage of the incoming path 11 bandwidth of the gateway network element 2, 3, 4 or 5. This is achieved as follows. Each gateway network element 2, 3, 4 and 5 receives information from the traffic stream controller 9 comprising the bandwidth of the traffic signals which the gateway network element 2, 3, 4 and 5 is to receive. Each gateway network element 2, 3, 4 and 5 then uses a bandwidth control algorithm to calculate the aggregate bandwidth of any traffic streams being carried by the incoming path 11 of the gateway network element 2, 3, 4 and 5 and each of the traffic streams which it is to receive. Each gateway network element 2, 3, 4 and 5 checks that this aggregate bandwidth does not exceed the incoming path 11 bandwidth, and may reject one or more of the traffic streams which it is to receive, if the aggregate bandwidth exceeds the incoming path bandwidth.

Control of routing of the traffic streams to a gateway network element 2, 3, 4 and 5 also comprises setting up a VC for each of the traffic streams within an outgoing path, for example outgoing path 12, carrying the traffic stream and the incoming path 11 of the gateway network element 2, 3, 4 and 5. Setting up a VC for each traffic stream for the gateway network element 2 comprises the following steps. The traffic stream controller 9 informs the gateway network element 2 that a traffic stream from a gateway network element, e.g. 5, is to be sent to it. The gateway network element 2 chooses a VCI for a VC for the traffic stream, and communicates the chosen VCI to the traffic stream controller 9. The traffic stream controller 9 communicates the VCI to gateway network element 5, and this gateway network element assigns its traffic stream to a VC having the chosen VCI communicated to it. The gateway network element 2 can therefore control the VCIs for the VCs for the traffic streams it receives, and can avoid receiving two different traffic streams on the same VC.

1-24. (canceled)

24. A telecommunications network, comprising:
a) a plurality of network elements;
b) switching means;
c) a traffic stream controller;
d) for each network element, there is provided a set of outgoing paths from the network element to the switching means, one of the outgoing paths carrying traffic streams for each of the network elements, and an incoming path carrying traffic streams from the switching means to the network element; and
e) to route traffic streams from each of the network elements to the network element, the switching means merges each outgoing path carrying traffic streams for the network element onto the incoming path of the network element, and routing of the traffic streams to the network element is controlled by the network element using the traffic stream controller.

25. The telecommunications network according to claim 24, in which each outgoing path comprises a permanent virtual path (PVP).

26. The telecommunications network according to claim 24, in which each incoming path comprises a permanent virtual path (PVP).

27. The telecommunications network according to claim 24, in which, for each network element, control of routing of the traffic streams to the network element comprises control of usage of bandwidth of the incoming path of the network element.

28. The telecommunications network according to claim 27, in which each network element controls usage of the incoming path bandwidth by using information received from the traffic stream controller.

29. The telecommunications network according to claim 28, in which the information received from the traffic stream controller comprises information concerning each of the traffic streams which the network element is to receive.

30. The telecommunications network according to claim 28, in which the information received from the traffic stream controller comprises information concerning bandwidth of each of the traffic streams which the network element is to receive.

31. The telecommunications network according to claim 30, in which each network element uses the information received from the traffic stream controller to calculate the aggregate bandwidth of any traffic streams being carried on the incoming path of the network element and each of the traffic streams which it is to receive.

32. The telecommunications network according to claim 31, in which each network element checks that the aggregate bandwidth does not exceed the incoming path bandwidth of the network element.

33. The telecommunications network according to claim 32, in which each network element rejects at least one of the traffic streams which it is to receive, if the aggregate bandwidth exceeds the incoming path bandwidth.

34. The telecommunications network according to claim 33, in which, for each network element, the incoming path bandwidth is less than or equal to the bandwidth of an egress port of the switching means from which the incoming path comes.

35. The telecommunications network according to claim 34, in which, for each network element, each outgoing path has a bandwidth less than or equal to the bandwidth of the network element incoming path onto which the outgoing path is merged.

36. The telecommunications network according to claim 35, in which, for each network element, control of routing of the traffic streams to the network element from each of the network elements comprises the network elements exchanging network element identities via the traffic stream controller.

37. The telecommunications network according to claim 24, in which, for each network element, control of routing of the traffic streams to the network element comprises setting up a virtual connection (VC) for each traffic stream, within an outgoing path carrying the traffic stream and the incoming path of the network element.

38. The telecommunications network according to claim 37, in which setting up each VC comprises allocating a VC identifier (VCI) to each VC.

39. The telecommunications network according to claim 38, in which allocating a VCI to each VC comprises the network element choosing a VCI for each VC.

40. The telecommunications network according to claim 39, in which allocating a VCI to each VC comprises the network element communicating a chosen VCI to each of the network elements of the telecommunications network.

41. The telecommunications network according to claim 40, in which communicating a chosen VCI is achieved via the traffic stream controller.

42. The telecommunications network according to claim 41, in which, for each network element, setting up a VC for a traffic stream comprises the following steps: the traffic stream controller informs the network element that a traffic stream is to be sent to it from a source network element; the network element chooses a VCI for a VC for the traffic stream; the network element communicates the chosen VCI to the traffic stream controller; the traffic stream controller communicates the chosen VCI to the source network element; and the source network element assigns the traffic stream to a VC having the VCI.

43. The telecommunications network according to claim 24, in which the telecommunications network routes CBR traffic streams.

44. The telecommunications network according to claim 24, in which the switching means comprises at least one switch of the telecommunications network.

45. The telecommunications network according to claim 24, in which, for each network element, the outgoing paths carrying traffic streams for the network element are merged in at least one stage using at least one switch of the switching means.
